(19) United States
(12) Patent Application Publication
(10) Pub. No.: US 2005/0288061 A1
(43) Pub. Date: Dec. 29, 2005

(54) Portable receiver with reduced dispersion

(75) Inventor: Christian Lamothe, Neuchatel (CH)

Correspondence Address: SUGHRUE MION, PLLC, 2100 Pennsylvania Avenue, NW, Washington, DC, 20037-3213, US

(73) Assignee: EM MICROELECTRONIC - MARIN SA

(21) Appl. No.: 10/629,898

(22) Filed: Jul. 30, 2003

(30) Foreign Application Priority Data
Jul. 31, 2002 (EP) 02078252.0.

(51) Int. Cl. H04M 1/00

(52) U.S. Cl. 455/562.1

(57) ABSTRACT

A portable receiver includes a first reception stage with three antennae (1, 2 and 3) oriented so as to form a substantially orthogonal coordinate system, a second stage (4, 5, 6, 7, 8 and 10) for processing the signals (V1, V2 and V3) delivered at the antennae outputs, and a third selection or combination stage (9) for the signals delivered at the output of the second processing stage. The processing stage and the third stage are arranged so as to provide an output signal independent of the position of the receiver in relation to the transmitter.

### BACKGROUND OF THE INVENTION

The present invention concerns a portable receiver particularly intended to applications within the automobile industry, for example for opening a vehicle by remote control, and more generally for applications for contactless detection systems.

The portable receiver includes a first reception stage comprising three antennae oriented so as to form a substantially orthogonal coordinate system, and capable of receiving an external signal within a given frequency range, a second stage for processing the signals delivered at the antennae outputs, and a third stage for selecting one of the signals delivered at output of the processing stage or a third stage combining the signals delivered at the processing stage output.

There is known in the prior art, particularly from FR document No. 2 763 186, as is shown in FIG. 1, a portable receiver with three antennae 1, 2 and 3, arranged perpendicularly in pairs and each receiving a component V1, V2 and V3, of an external signal along their axis. Amplifier means 4, 5 and 6 placed at the output of each antenna allow three amplified signals V4, V5 and V6 to be delivered. These three signals V4, V5 and V6 are provided, according to a first embodiment, at the input of an adder 7 and according to a second embodiment, at the input of selection means 7 of the signal having the largest amplitude.

FIG. 2 shows an orthogonal coordinate system, defined by the axes of the three antennae, in which it is possible to resolve external signal V0·cos (wt) received in three components V1, V2 and V3 defined by the following formulae:
V1=V0·cos (wt)·sin (a)·cos (b);
V2=V0·cos (wt)·cos (a)·cos (b);
V3=V0·cos (wt)·sin (b);
where V0 represents the amplitude and cos (wt) the phase of the external signal received by the portable receiver. The signals V4, V5 and V6 differ only from signals V1, V2 and V3 in that they introduce a gain factor G due to the two amplifiers placed at the antennae outputs.

This receiver has, however, several drawbacks. According to the first embodiments using an adder, there exist several reception blind spots. When the portable receiver, for example an automobile vehicle key, is oriented in relation to the transmitter, for example the automobile vehicle, such that the portable receiver does not receive any signals, whatever the distance between the transmitter and the receiver, is called a reception blind spot.

Indeed, according to this first embodiment, the sum of the signals (V4+V5+V6) obtained at the adder output is cancelled out when:
cos (b)·(sin (a)+cos (a))+sin (b)=0;
This equation is particularly checked for the following pairs a and b:
a=0 and b=−pi/4;
a=pi/2 and b=−pi/4;
a=pi/4 and b=0;
   Thus, there exist at least three reception blind spots for the aforementioned pairs.

One of the primordial elements in such contactless detection systems lies in the necessity of having a receiver with reduced dispersion. Dispersion or dispersion zone means the spatial zone in which the reception or non-reception of signals from the transmitter depends on the orientation of the receiver in relation to the transmitter. The dispersion factor is defined by the amplitude extrema of the signal delivered at the output of the adder or the receiver selection means.

According to the first embodiment presented in FR document No. 2 763 186, in the dispersion zone, the maximum amplitude is equivalent to the amplitude of the external signal, to within a gain factor introduced by the amplifiers.

Indeed, the output signal has maximum amplitude when one of antennae 1, 2 or 3 is oriented along the axis of the transmitter, for example:
V4=G·V1=GV0·cos (wt);
V5=V6=0.

According to this first embodiment, the output signal has minimum amplitude for each reception blind spot. In these cases, the amplitude is zero. Thus, the dispersion factor varies between 0 and 1. In the entire transmission zone of the transmitter in which the receiver is supposed to operate, the actual reception will thus depend upon the orientation of the receiver in relation to the transmitter.

According to the second embodiment, the receiver uses means for selecting the signal with the largest amplitude. The selected signal has maximum amplitude when one of antennae 1, 2 or 3 is oriented along the transmitter axis, which gives, for example:
V4=G·V0·cos (wt);
V5=V6=0.
The selected signal V4, V5 or V6 has minimum amplitude when the amplitude of the signals received by each of the three antennae is equal. There is thus the following equation:
V4=V5=V6;
Which implies:
cos a=sin a;
cos² b=sin² b.
A signal with minimum amplitude is thus obtained, for example:
V4=⅓·V0·cos (wt);

The solution according to this second embodiment thus has a dispersion factor varying between 1/√3 and 1. Dispersion is thus of the order of 42%, which can be, to a certain extent, a drawback for reasons of security or facility of use. Moreover, the selection means receive three signals from among which the one with the largest amplitude is selected, which require relatively complex processing. Firstly, the selection means must know the amplitude of the three signals V4, V5 and V6, and secondly compare the three signals in pairs, the selection only being able to occur once all these operations have been carried out.

Further still, the solutions according to these two embodiments require the use of three amplifiers, which involves a large consumption of energy in the receiver. One of the constant concerns of those skilled in the art is to reduce energy consumption as much as possible in order to increase the autonomy of such a portable receiver.

Furthermore, there is also known in the prior art, particularly from FR document No. 2 792 129, as is shown in FIG. 3, a portable receiver with two antennae 11 and 12, oriented perpendicularly in relation to each other. A phase-shifter circuit 13, 14 is arranged at the output of each of the antennae, signals V11, V12 delivered by the antennae being then theoretically phase-shifted by +45° and −45°, which theoretically still enables signals V13, V14 to be obtained at the output of phase-shifter circuits 13 and 14 phase-shifted by 90° in relation to each other. These signals V13 and V14 are then provided to a subtracter 15, which allows the external signal received by the antennae to be reconstituted.

This solution has, however, several drawbacks. The receiver only has two antennae, and thus only receives the external signals in the plane formed by these two antennae. This receiver thus can only receive in two directions, the third direction corresponding to a reception blind spot. Moreover, the solution presented in this document does neither take account of subtracter 15 placed at the output of phase-shifter circuits 13 and 14, nor of the peculiar features of antennae 11 and 12, which means failure to respect the desired phase-shifts and thereby no longer ensures the desired amplitude stability.

### SUMMARY OF THE INVENTION

It is thus an object of the present invention to overcome the aforementioned drawbacks by providing a portable receiver having reduced dispersion while consuming a minimum of energy.

Thus the portable receiver according to the invention, in the case of a third selection stage, in addition to satisfying the definition given in the description introduction, is characterised in that said second processing stage includes first and second phase-shifters connected at the output of two of said antennae, said signals delivered at the output of these two antennae being phase-shifted by an angle of π/2 or 3π/2 in relation to each other, and means for combining said phase-shifted signals forming a first signal delivered to said third selection stage, in that said signal delivered by the third antenna corresponds to a second signal delivered to said third selection stage, and in that said third selection stage includes means for selecting from among said two signals delivered at the output of said second stage, either the signal having the largest amplitude, or one of two signals having a larger amplitude than a reference amplitude, or arbitrarily one of the two signals if they have the same amplitude.

Or, according to an alternative, in the case of a third combination stage, the portable receiver according to the invention, in addition to satisfying the definition given in the description introduction, is characterised in that said second processing stage includes first and second phase-shifters connected at the output of two of said antennae, said signals delivered at the output of these two antennae being phase-shifted by an angle of π/2 or 3π/2 in relation to each other, and means for combining said phase-shifted signals forming a first combined signal provided at the input of first square-law step-up means, and in that said second processing stage further includes corrector means for correcting the attenuation introduced by the first and second phase-shifters in series with second square-law step-up means, and in that said third combination stage includes an adder receiving at input the output signals of said first and second square-law step-up means.

### BRIEF DESCRIPTION OF THE DRAWINGS

Other advantages will appear in light of the description provided solely by way of example, and illustrated by the annexed drawings, in which:

FIG. 1, already described, shows a portable receiver according to a prior art;

FIG. 2, already described, shows an orthogonal coordinate system defined by the axes of the three antennae, in which is it possible to break down the received external signal into three components;

FIG. 3, already described, shows a portable receiver according to a second prior art;

FIG. 4 shows a portable receiver according to a first embodiment according to the invention;

FIG. 5 shows a portable receiver according to a second embodiment according to the invention;

FIG. 6 shows a portable receiver according to a third embodiment of the invention.

### DETAILED DESCRIPTION OF THE PREFERRED EMBODIMENTS

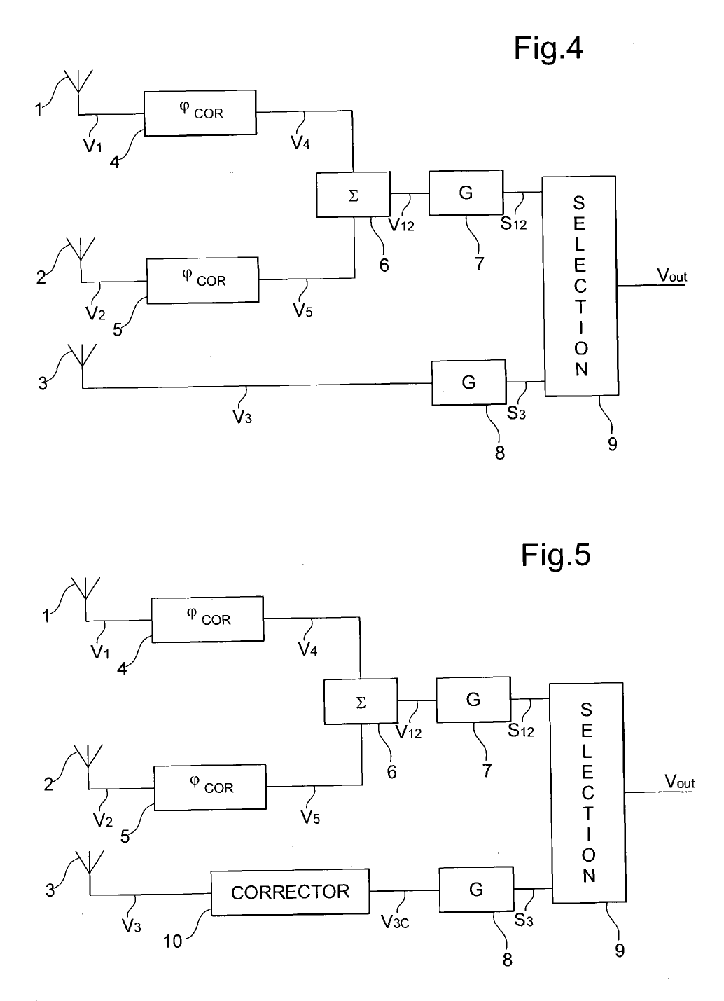

According to a first embodiment of the invention, as shown in FIG. 4, the receiver includes three antennae 1, 2 and 3 forming an orthogonal coordinate system. At the output of antennae 1 and 2, there are arranged phase-shifters 4 and 5, for example RC and CR phase-shifters, for phase-shifting signals V1 and V2 delivered by the antennae. The two phase-shifted signals V4 and V5 are provided at the input of an adder 6, or a subtracter, as a function of the direction of orientation of the antennae. Signal V12 delivered at the output of adder 6, or the subtracter, must have substantially constant amplitude, which means there is no dispersion in the plane formed by these two antennae 1 and 2. It has been demonstrated, within the scope of European Patent Application No. 01203712.3, whose particular embodiments of FIGS. 4 and 5 are incorporated herein by reference, that the adder or subtracter used introduces generally negligible stray components, not shown, including in particular a stray capacitance of the order of magnitude of the capacitances used in RC and CR phase-shifters. These stray components have the effect of varying the phase shifting between the two signals V4 and V5, and consequently the amplitude of signal V12, as well as the dispersion factor. This is why, correction means are provided incorporated in units (φ_{COR}) representing phase-shifter circuits 4 and 5. These correction means are formed for example of a correction resistor as in the embodiment of FIG. 4 of European Patent Application No. 01203712.3, this correction resistor being defined by the following value:

Rcor=(Rant*Req)/(Req−Rant), where Rant is the internal resistance of the corresponding antenna, where Req is the equivalent resistance of the corresponding phase-shifter circuit, Req being greater than or equal to Rant.

Correction capacitors can also be provided, the capacitances of the two correction capacitors being given by the following formula:

Ccor=Cant−Ceq, where Cant is the internal capacitance of the corresponding antenna and where Ceq is the equivalent capacitance of the corresponding phase-shifter circuit and the corresponding input of the multiplexing means, Cant being greater than or equal to Ceq.

These correction means allow a constant phase-shift of 90° to be obtained between the two phase-shifted signals V4 an V5, and a constant amplitude of signal V12 at the output of the adder or subtracter, as well as a dispersion factor that does not vary in the plane formed by these two antennae, i.e. equal to 1. Signal V12 obtained at the output is then amplified in an amplifier 7 which provides a signal S12 to selection means 9.

The third antenna 3 delivers a signal V3 which is also amplified in another amplifier 8, which provides a second signal S3 to selection means 9. Selection means 9 select either the signal having the largest amplitude, simply by comparing the two signals S12 and S3 provided to its inputs, or compare signal S12 to a reference signal Sref and select this signal S12 if its amplitude is larger than that of reference signal Sref, and otherwise compare signal S3 to reference signal Sref, and select signal S3 if its amplitude is greater than that of reference signal Sref. If neither of the two signals S12 and S3 has sufficient amplitude, the receiver cannot receive because it is too far from the transmitter, its sensitivity then being insufficient. Thus, reception no longer depends on the orientation of the receiver in relation to the transmitter. It is to be noted that it is possible to combine the two signal selection alternatives. Finally, if the two signals S12 and S3 have the same amplitude, one of the two signals is arbitrarily selected.

Study of dispersion, according to this first embodiment of the invention, shows that:

S12=G·√2/2·V0·cos b;
S3=G·V0·sin b;
A signal Vout with minimum amplitude is obtained at output, for sin b=1:
Vout=G·V0;
A signal Vout with minimum amplitude is obtained at output, when:
S12=S3;
Namely:
√2/2·cos b=sin b;
which gives:
cos b=√(2/3);
sin b=1/√3;
hence:
Vout=G·V0/√3.

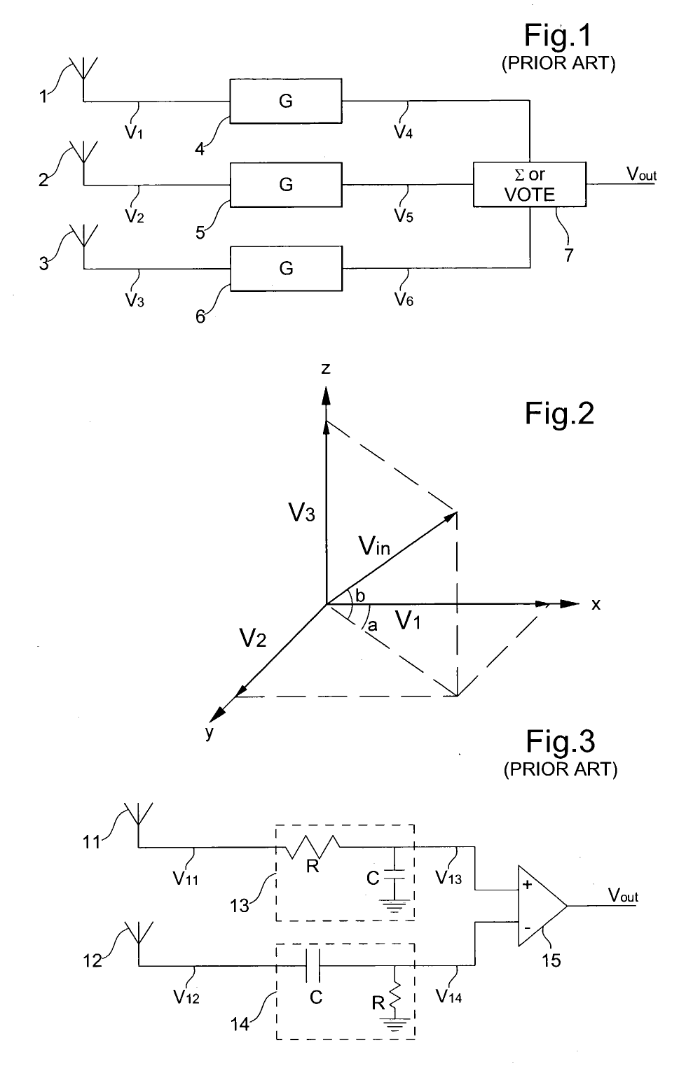

The amplitude dispersion varies by a factor of 0.58 to 1. However, this solution has the advantage in relation to the solution of the prior art shown in FIG. 1, of using only amplifiers 7 and 8, which means a reduction in the energy consumption of the circuit.

According to a second embodiment of the invention, shown in FIG. 5, starting with the same reception circuit as that described in FIG. 4, corrector means 10 are provided at the output of the third antenna 3.

Indeed, within the scope of the present invention, it has been demonstrated that phase-shifter circuits 4 and 5 used at the output of the first 1 and second 2 antennae introduce an attenuation of the order of √2/2.

Corrector means 10 used for correcting this observed attenuation are preferably placed before amplifier 8, which allows the receiver circuit to be given better symmetry. However, it is possible to place these corrector means after the amplifier.

The signals received by the antennae 1, 2 and 3 are of the shape:
V1=V0·cos (wt)·sin a·cos b;
V2=V0·cos (wt)·cos a·cos b;
V3=V0·cos (wt)·sin b.

The processing of these first two ways remains identical to what was seen for the first embodiment shown in FIG. 4. The signal module delivered at the output of adder 6, or the subtracter used is in the following shape:
V12=√2/2·V0·cos b;

For the third antenna 3, corrector means 10 allow the effects of stray components to be corrected, but also the attenuation introduced by phase-shifters 4 and 5 of the first two channels to be corrected. These corrector means 10 are for example formed by a simple resistive attenuator R1 and R2 where the resistance values are suitably chosen so as to obtain the desired attenuation (√2/2). One would take for example:
R1=(2−√2)·R, and
R2=√2·R;

The signal module delivered at the output of corrector means 10 is given by the following formula:
V3c=√2/2·V0·sin b;

Thus, after amplification in the two amplifiers 7 and 8, the following two signals S12 and S3 are obtained at the input of selection means 9:
S12=G·V12;
S3=G·V3c;
An output signal Vout with a maximum amplitude is obtained for example for cos b=1:
Vout=√2/2·V0;
An output signal Vout with minimum amplitude is obtained when:
S12=S3;
Namely:
cos b=sin b;
Hence:
Vout=½·V0;
The amplitude dispersion varies by a factor of 0.71 to 1.

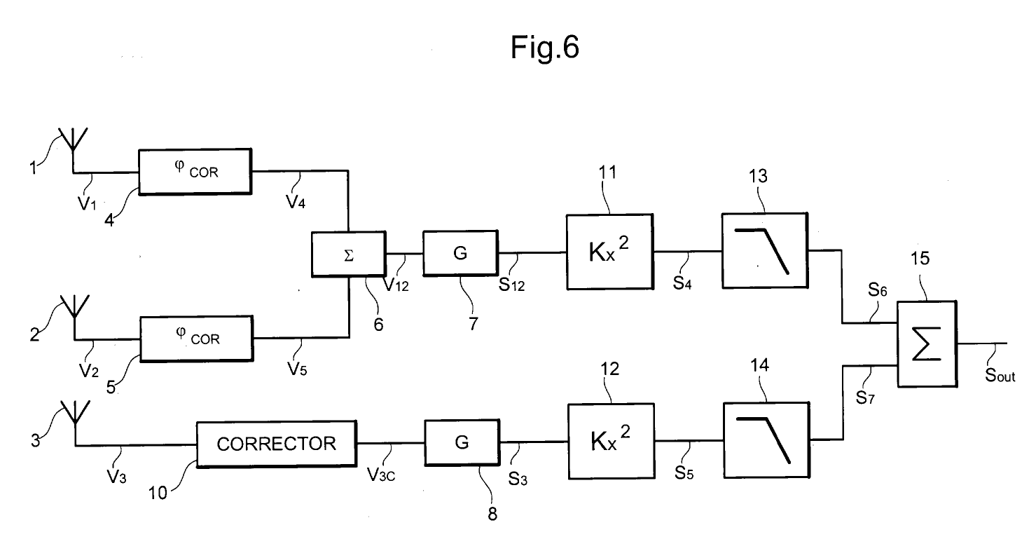

According to a third embodiment of the invention, shown in FIG. 6, starting with the same reception circuit as that described in FIG. 5, the third selection stage, comprising the selection means provided at output, is replaced by a third combination stage and square-law step-up means 11 and 12 are added to the second processing means, placed at the output of the amplifiers, respectively 7 and 8, preferably in series with low-pass filtering means, respectively 13 and 14, for filtering the high frequencies and recuperating the continuous signal component. The third combination stage includes an adder 15 placed at the output of the filtering means to combine the received signals.

As in the case of the second embodiment, after amplification in the two amplifiers 7 and 8, the following two signals S12 and S3 are obtained at the input of square-law step-up means 11 and 12:
S12(t)=G·√2/2·V0·cos b·cos (wt);
S3(t)=G·√2/2·V0·sin b·cos (wt)

After stepping up to square-law in the two square-law step-up means 11 and 12, chosen for example with an equal coefficient k, the following two signals S4 and S5 are obtained:
S4(t)=k·S12²(t)=k·(G·√2/2·V0·cos b)²·cos² (wt);
S5(t)=k·S3²(t)=k·(G·√2/2·V0·sin b)²·cos² (wt);

After filtering in low pass filtering means 13 and 14, a quasi continuous component of signal S6 and S7 is retrieved
S6=k/2·(G·√2/2·V0)²·cos² b;
S7=k/2·(G·√2/2·V0)²·sin² b;
After adding together signals S6 and S7 in adder 15, the following output signal Sout is obtained:
Sout=k/4·V0²;
Dispersion due to the position of the receiver in relation to the transmitter is thus cancelled out.

It is clear that the description is given only by way of example and that other embodiments, in particular correction means, can form the subject of the present invention.

1. A portable antenna comprising a first reception stage including three antennae oriented so as to form a substantially orthogonal reference mark, capable of receiving an external signal within a given frequency range, a second processing stage for the signals delivered at the outputs of said antennae, and a third stage for selecting one of the signals delivered at the output of said second processing stage, wherein said second processing stage includes first and second phase-shifters connected at the output of two of said antenna, said signals delivered at the output of these two antennae being phase-shifted by an angle of π/2 or 3π/2 in relation to each other, and means for combining said phase-shifted signals forming a first signal delivered to said third selection stage, wherein said signal delivered by the third antenna corresponds to a second signal delivered to said selection stage, and wherein said third selection stage includes means for selecting from among said two signals delivered at the output of said second stage, either the signal having the largest amplitude, or one of the two signals having an amplitude larger than a reference amplitude, or arbitrarily one of the two signals if they have the same amplitude.

2. The portable receiver according to claim 1, wherein corrector means for correcting the attenuation introduced by the first and second phase-shifters, are placed between said third antenna and the corresponding input of said selection means.

3. The portable receiver according to claim 2, wherein a first amplifier is placed between the means for combining the phase-shifted signals and said selection means and wherein a second amplifier is placed between the corrector means and said selection means.

4. A portable receiver comprising a first reception stage including three antennae oriented so as to form a substantially orthogonal reference mark, capable of receiving an external signal within a given frequency range, a second stage for processing the signals delivered at the outputs of said antenna, and a third stage for combining the signals delivered at the output of said second processing stage, wherein said second processing stage includes first and second phase-shifters connected at the output of two of said antennae, said signals delivered at the output of these two antennae being phase-shifted by an angle of π/2 or 3π/2 in relation to each other, and means for combining said phase-shifted signals forming a first combined signal provided at the input of first means for raising to the second power, wherein said second processing stage further includes corrector means placed at the output of the third antenna, to correct the attenuation introduced by the first and second phase-shifters in series with second means for raising to the second power, and wherein said third combination stage includes an adder receiving at input the signals provided at the output of said first and second means for raising to the second power.

5. The portable receiver according to claim 4, wherein said second processing stage further includes first and second filtering means respectively placed between said first and second means for raising to the second power and the adder.
